(19) United States
(12) Patent Application Publication
(10) Pub. No.: US 2008/0266124 A1
(43) Pub. Date: Oct. 30, 2008

(54) Domestic water leak automatic detectioin and control

(76) Inventor: Edward C. Wofford, Nampa, ID (US)

Correspondence Address: Edward C. Wofford, 12694 Wild Rose Ln., Nampa, ID, 83686, US

(21) Appl. No.: 10/254,043

(22) Filed: Feb. 10, 2003

(51) Int. Cl. G08B 21/00

(52) U.S. Cl. 340/605

(57) ABSTRACT

The Domestic Water Leak Automatic Detection and Control is a system to be installed in the home to detect any water leaks from plumbing, appliances and spills. The system is designed for the home owner to be simple and intuitive in nature. No setup or programming is required by the owner. Indicators assure the normal operation of the system. When an abnormal condition occurs, the system controller alerts by both visual and aural means and turns off the main water supply to the home.

### DETECTOR DESCRIPTION

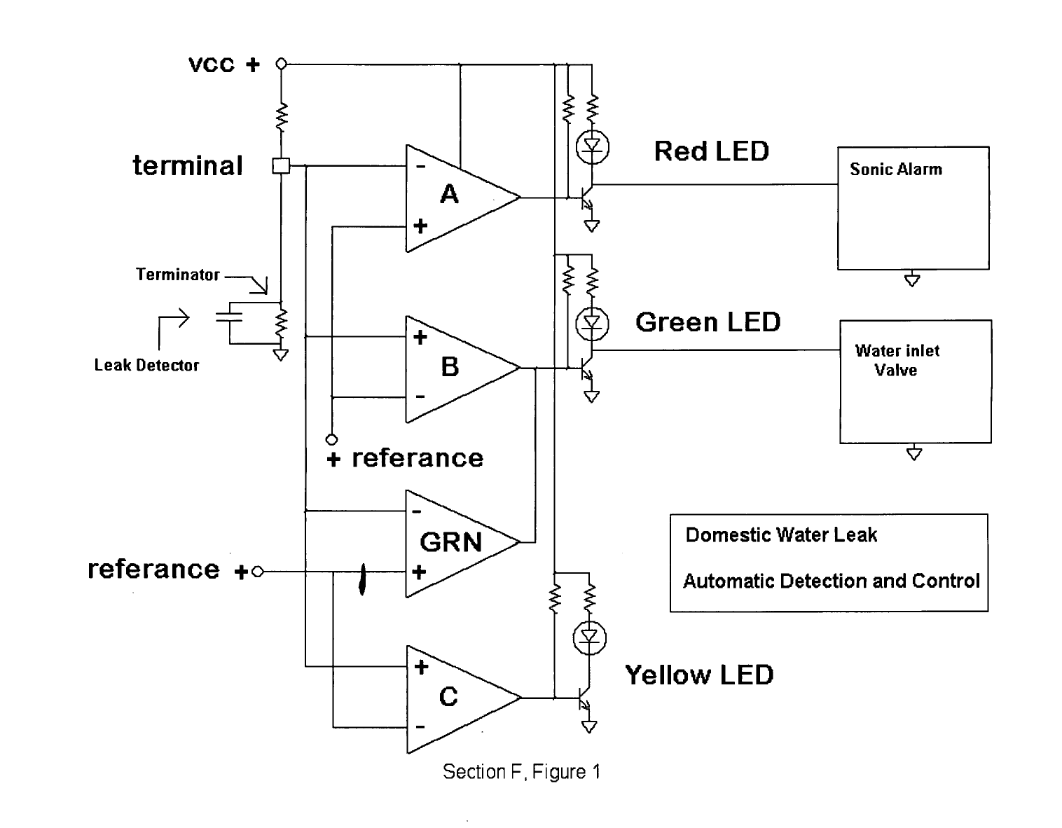

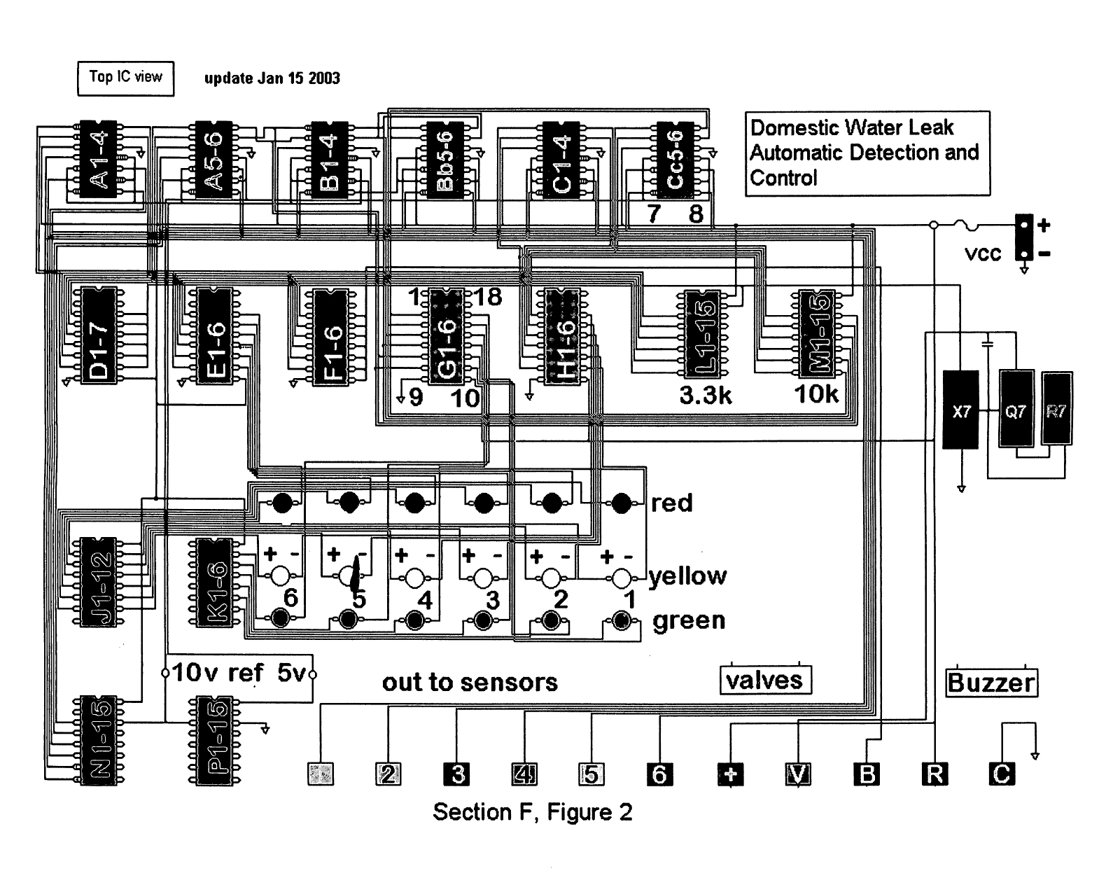

A system designed to detect water leaks in any home. Water detectors would be located at all potential sources of water leakage. Examples: washing machine, ice-maker, hot water tank, dishwasher, sinks, tubs, showers, water lines. The detectors in turn connect to a central controller, (Section F, FIG. 2). The detector consists of two grids separated by an element saturated in sodium chloride, (Section F, FIG. 1, labeled Leak Detector). When water is present in the detector a small electrical current is sent to the controller. A terminator, (Section F, FIG. 1), connected across the detector allows the controller to monitor for an open circuit, (fault, Yellow LED) and present a warning.

### CONTROLLER DESCRIPTION

The central controller receives the current signals from the various fields of detectors and compares these to a set of standards, (Section F, FIG. 1, Reference), to determine the states of: Normal, Open Sensor, Leak Detection. The field conditions are indicated by visual lights: Green, Yellow, Red, (Section F, FIG. 1). When the controller determines that there is a LEAK condition, the Red light comes on to indicate the offending field location and the sonic alarm is sounded. The controller then turns off the main water supply to the home by means of a standard low voltage electric water valve, (Section F, FIG. 1, Water inlet Valve). The complete system uses low voltage and low current power supplies for complete safety in the domestic environment.

### PURPOSE OF THE DEVICE

To add positive security to the home by constantly monitoring the moisture condition in the total environment, reducing the possible damage to the home it's self. Long term and very slow leaks, previously undetected by conventional methods, are detected and the home owner alerted so he may make necessary repairs thereby removing the source for the growth of mold. Mold, undetected has been known to damage structures and create a hazardous health environment.

### ADVANTAGE

Present existing approaches to the problem of water leaks in the domestic environment either are too costly or complex for the typical home owner. Industrial solutions are both costly and complex. The approach of monitoring water flow with a special inlet valve and a programmer require the operator to have expertise in programming. This approach does not cover all ways that water damage could occur.

### SUMMARY

The Domestic Water Leak Automatic Detection and Control is perfectly suited for the home in initial investment and operation. The system is completely automatic, requires no adjustments or service. The system allows the home-owner to perform simple tests to assure the proper operation of all components. Only in the event of abnormal conditions is the home owner alerted. He then can take the proper action.

What is claimed is:

1. A system to be installed in a home to detect undesired intrusion of moisture from small amounts of water or humidity from multiple sources, (water main, appliance faults, drain breaks, spills, creek overflow, roof leaks, basement and crawl leakage, high humidity), into areas that could not be observed by normal inspections comprising of:
(a) A number of zones, each with its own cluster of sensors.
(b) A central processor to route the signals from the zones and register humidity status of the area.
(c) Separate power supply to reduce grid power consumption to microwatts, (instead of just low voltage), and to provide lightening protection.
(d) Circuit to enable the processor to provide a direct current pulse to hold the main water valve open while utilizing considerably less power.
(e) Solid state references to eliminate field adjustments and provide system reliability.
(f) Zone termination circuits to act as feedback to the central processor.

1. Zones consist of areas in the building that are comprised of multiple sensors, with each zone terminated and hardwired to the central processor, bypassing air waves and frequency interference as claimed in 1.

2. The processor is located centrally for convenience in order to confirm consistent readings as in claim 1.

3. The power supply is located close to the processor and in such a fashion as to provide protection from high line power surges in claim 1.

4. Processor, in claim 1, receives sensor input from multiple zones and compares data to internal references, then commands the standard, (off the shelf), main water valve, the status indicators and enunciators as depicted in drawing (Section F, FIG. 1).

5. (Section F, FIG. 2) Multiple circuits and power distribution in claim 1 confirm the lack of field adjustment hardware.

6. The processor status enunciators in claim 1, shown in (Section F, FIGS. 1 & 2) are labeled Red, Green Yellow LED and Sonic Alarm.
